(19) United States
(12) Patent Application Publication
(10) Pub. No.: US 2024/0422189 A1
(43) Pub. Date: Dec. 19, 2024

(54) TECHNIQUES FOR MITIGATING CYBER VULNERABILITIES AND EXPOSURES IN COMPUTING INFRASTRUCTURE

(71) Applicant: Zafran Security LTD, Tel Aviv (IL)

(72) Inventors: Snir HAVDALA, Tel Aviv (IL); Ben SERI, Ramat Gan (IL)

(73) Assignee: Zafran Security LTD, Tel Aviv (IL)

(21) Appl. No.: 18/334,007

(22) Filed: Jun. 13, 2023

(51) Int. Cl. H04L 9/40

(52) U.S. Cl. CPC H04L 63/1441; H04L 63/1433

(57) ABSTRACT

A system and method for mitigating vulnerabilities and exposures. A method includes: determining at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and performing the at least one mitigation action via at least one mitigation engine of the plurality of mitigation engines.

### TECHNICAL FIELD

The present disclosure relates generally to securing computing infrastructure against cybersecurity threats, and more specifically to mitigating potential cyber vulnerabilities in computing infrastructure.

### BACKGROUND

Cyber vulnerabilities refer to weaknesses or flaws in software, hardware, or network systems which could be exploited by cyber attackers in order to gain unauthorized access, to steal or manipulate data, or to disrupt critical operations. These vulnerabilities can be caused by various factors such as, but not limited to, programming errors, misconfigurations, outdated software, or lack of security awareness.

Cyber vulnerabilities (also sometimes simply referred to as vulnerabilities) can cause severe consequences for individuals, businesses, governments, and other organizations. These consequences can include financial losses, reputational damage, and even threats to national security. It is crucial for many entities to identify and mitigate cyber vulnerabilities through regular security assessments, updates, and training, in order to reduce the risk of cyber-attacks.

New vulnerabilities are constantly being discovered and reported, for example, in the form of entries in common vulnerabilities and exposures (CVE). CVE is a database with entries representing known vulnerabilities and exposures, and can be used to provide a common definition of any given vulnerability or exposure when communicating between different entities. Entries may be given identifiers such as a CVE number that are unique to each vulnerability or exposure in the CVE, and vulnerabilities and exposures can be referenced by their respective identifiers. In a CVE, a vulnerability is typically a weakness which can be exploited to gain unauthorized access or otherwise to perform unauthorized actions, while an exposure is a state in which an attacker has access to a system or network which it should not have.

The number of vulnerabilities being discovered has grown exponentially over the years. Timely mitigation of such vulnerabilities is key to securing computing assets against cyber threats. The ever-increasing number of vulnerabilities makes timely mitigating vulnerabilities increasingly challenging.

Some existing mitigation techniques include applying security patches, conducting security assessments, implementing access controls, and employing security technologies.

For security patches, vendors may release security patches to fix known vulnerabilities. Keeping hardware and software up-to-date with the latest patches can significantly reduce the risk of exploitation.

Security assessments may include vulnerability scans, penetration testing, code reviews, and the like. Conducting security assessments using experienced personnel regularly may help to identify vulnerabilities which might be missed by automated tools and/or untrained personnel.

Access controls may include passwords, two-factor authentication, privilege controls, and the like. Implementing access controls can limit access to sensitive systems and data, and may therefore reduce the risk of unauthorized access.

Security technologies such as firewalls, intrusion detection and prevention systems, antivirus software, and encryption can help protect against attacks and mitigate the impact of any successful attacks.

All of these techniques, while beneficial for reducing harm of cyber threats, face challenges that would be desirable to improve. In particular, many of these techniques require manual human intervention, which may slow response times and is subject to human error. Even further, some of these techniques may require human operators to use their own judgment, which can be a subjective process that yields different results for different operators.

Additionally, the reality of existing solutions is that vulnerabilities which are ultimately introduced into a computing environment can take a very long time to fix, which leaves open a large exploitation window in which the vulnerability can be exploited. A typical vulnerability lifetime may be like the following: vulnerability is introduced in a release at day 1, the vulnerability begins to be exploited at day 9, and code is patched to prevent the vulnerability at day 60 or later. Such a long window allows a lot of harm to potentially come from a given exploited vulnerability, which is compounded as the number of vulnerabilities and the number of assets to be protected increase.

It would therefore be advantageous to provide a solution that allows for better, faster, more objective, more accurate, and automated mitigation of vulnerabilities in computing environments.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for mitigating vulnerabilities and exposures. The method comprises: determining at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and performing the at least one mitigation action via at least one mitigation engine of the plurality of mitigation engines.

Certain embodiments disclosed herein also include a non-transitory computer readable medium having stored thereon causing a processing circuitry to execute a process, the process comprising: determining at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and performing the at least one mitigation action via at least one mitigation engine of the plurality of mitigation engines.

Certain embodiments disclosed herein also include a system for mitigating vulnerabilities and exposures. The system comprises: a processing circuitry; and a memory, the memory containing instructions that, when executed by the processing circuitry, configure the system to: determine at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and perform the at least one mitigation action via at least one mitigation engine of the plurality of mitigation engines.

Certain embodiments disclosed herein include the method, non-transitory computer readable medium, or system noted above or below, further including or being configured to perform the following steps: causing deployment of at least one instance of an artifact in a computing infrastructure, wherein the at least one mitigation action is performed via the deployed at least one instance of the artifact.

Certain embodiments disclosed herein include the method, non-transitory computer readable medium, or system noted above or below, wherein the at least one instance of the artifact is configured to track mitigation activities performed in the computing infrastructure in order to create a record of the mitigation activities performed in the computing infrastructure, wherein the at least one mitigation action is determined based on the record.

Certain embodiments disclosed herein include the method, non-transitory computer readable medium, or system noted above or below, further including or being configured to perform the following steps: defining the artifact via a set of executable instructions; and causing enforcement of at least one policy requiring signing code releases in the computing infrastructure with respective instances of the artifact, wherein the at least one instance of the artifact is deployed via the enforcement of the at least one policy.

Certain embodiments disclosed herein include the method, non-transitory computer readable medium, or system noted above or below, further including or being configured to perform the following steps: performing impact analysis on the first vulnerable state in order to determine an impact score for the first vulnerable state, wherein the at least one mitigation action is performed based on the impact score for the first vulnerable state.

Certain embodiments disclosed herein include the method, non-transitory computer readable medium, or system noted above or below, wherein the at least one mitigation action is at least one first mitigation action, further including or being configured to perform the following steps: prioritizing the at least one first mitigation action with respect to a plurality of second mitigation actions based on the impact analysis.

Certain embodiments disclosed herein include the method, non-transitory computer readable medium, or system noted above or below, further including or being configured to perform the following steps: selecting the at least one mitigation engine from among the plurality of mitigation engines based on the prioritizing of the at least one first mitigation action with respect to the plurality of second mitigation actions.

Certain embodiments disclosed herein include the method, non-transitory computer readable medium, or system noted above or below, wherein the plurality of mitigation engines includes a reachability mitigation engine, wherein the determined at least one mitigation action includes adjusting a configuration of at least one component in a path of reachability between the first vulnerable state and at least one asset.

Certain embodiments disclosed herein include the method, non-transitory computer readable medium, or system noted above or below, wherein the plurality of mitigation engines includes a runtime mitigation engine, wherein the determined at least one mitigation action includes altering executable code at runtime.

Certain embodiments disclosed herein include the method, non-transitory computer readable medium, or system noted above or below, wherein the altering of the executable code at runtime includes modifying at least one of: at least one function, and at least one rule.

Certain embodiments disclosed herein include the method, non-transitory computer readable medium, or system noted above or below, wherein the plurality of mitigation engines includes a compiler time mitigation engine, wherein the determined at least one mitigation action includes altering compiler time code.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIGS. 1A-B are network diagrams utilized to describe various disclosed embodiments.

FIG. 2 is a flow diagram illustrating a process including vulnerable state mitigation.

FIG. 3 is a flowchart illustrating a method for mitigating vulnerable states in computing infrastructure according to an embodiment.

FIG. 4 is a flowchart illustrating a method for integrating a mitigation tool in a computing infrastructure according to an embodiment.

FIG. 5 is a flowchart illustrating a method for prioritizing vulnerable states based on impact analysis according to an embodiment.

FIG. 6 is a flowchart illustrating a method for performing mitigation actions in a computing infrastructure according to an embodiment.

FIG. 7 is a schematic diagram of a mitigator according to an embodiment.

### DETAILED DESCRIPTION

The various disclosed embodiments include methods and systems for mitigating cyber vulnerabilities in computing environments. In accordance with various disclosed embodiments, a mitigation knowledge base is created on a per-vulnerable state basis with respect to different mitigation engines, where each mitigation engine is configured to perform respective mitigation activities. The mitigation knowledge base defines one or more mitigation actions to be performed for different vulnerable states, where each of the mitigation actions is among the mitigation activities one of the mitigation engines is configured to perform. The vulnerable states may include, but are not limited to, vulnerabilities or exposures, for example vulnerabilities and exposures defined in a common vulnerabilities and exposures (CVE) database. Using such a mitigation knowledge base to determine mitigation engines to use and mitigation actions to perform via each mitigation engine allows for mitigating vulnerabilities in an effective and scalable manner, namely, by minimizing changes made via mitigation actions to optimize mitigation effectiveness while avoiding potential harm to the stability and reliability of these systems.

When a vulnerable state is detected or otherwise identified, mitigation actions to be performed are determined using the mitigation knowledge base. One or more of the mitigation engines are used in order to perform the mitigation actions. In an embodiment, the mitigation engines include any or all of a reachability mitigation engine, a runtime mitigation engine, and a compile time mitigation engine. The reachability mitigation engine is configured to adjust configurations of component in-path of potential paths of exploitation for detected vulnerable states. The runtime mitigation engine is configured to alter executable code at runtime. The compile time mitigation engine is configured to alter compiler code for subsequent execution.

In support of the mitigation actions performed as described herein, the various disclosed embodiments further include techniques for impact analysis which may be utilized in order to prioritize vulnerable states. This, in turn, allows for prioritizing mitigation actions to further improve mitigation and reduce potential harm by cyber threats. The impact analysis may be performed based on factors such as, but not limited to, whether each vulnerable state is detected in a process or system having built-in processes, whether each vulnerable state imposes a path of exploitation, a severity of each vulnerable state, a reachability of each vulnerable state to a network through which protected assets can be accessed, complexity of trigger conditions for triggering the vulnerable state (e.g., to trigger the state to cause improper exposure of assets or otherwise grant improper access), and the like. The impact analysis techniques described herein may be utilized to reduce the number of false positives, thereby allowing for faster and more efficient reactions to higher impact vulnerabilities.

The impact analysis process, in accordance with various disclosed embodiments, allows for reducing false positive identifications of potential cyber threats and otherwise allows for efficiently prioritizing most likely threats, which in turn improves the security of the infrastructure. Such an impact analysis may include, but is not limited to, analyzing runtime of production systems as well as calculating risks of potential vulnerabilities based on security controls within the infrastructure and known effectiveness of different security controls against certain kinds of vulnerabilities.

In addition to the other benefits described herein, the disclosed embodiments allow for optimizing efforts in mitigating risks of vulnerabilities as quickly as possible, as efficiently as possible, and without introducing significant stability and reliability risk to production environments. Various disclosed embodiments can be orchestrated and automated in order to scale operations and achieve the various benefits discussed herein.

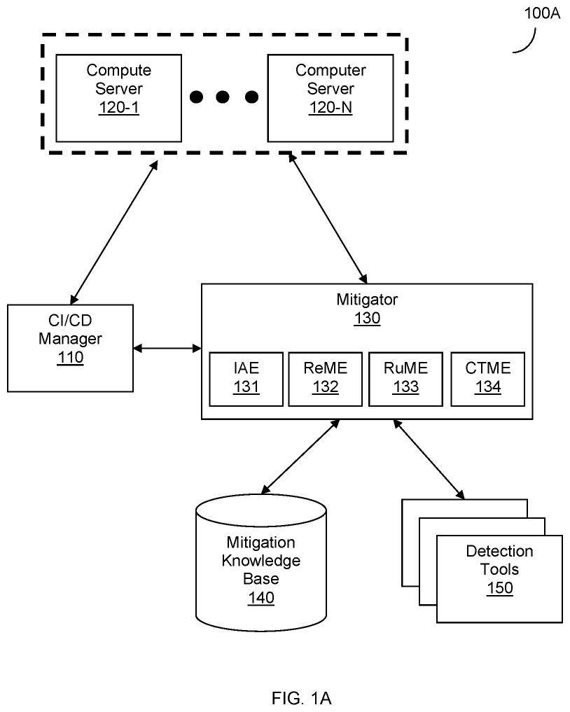

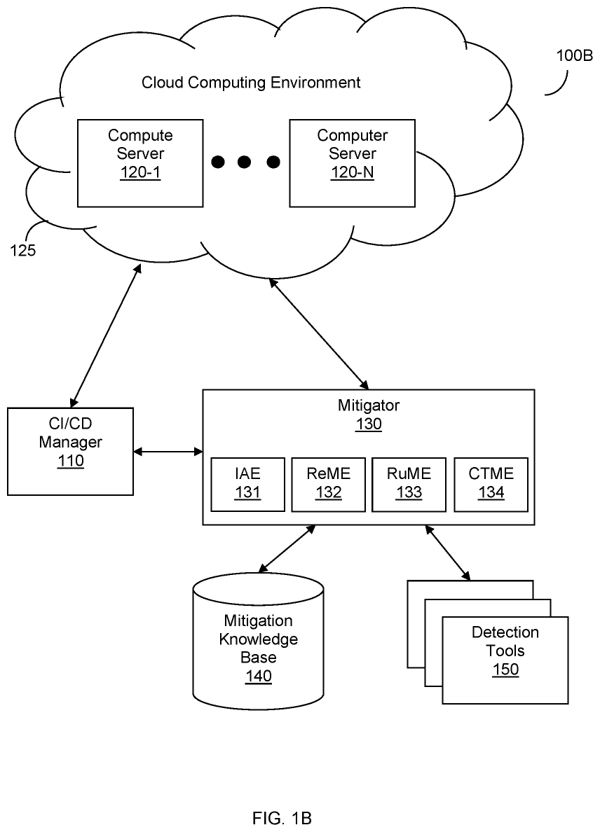

FIGS. 1A and 1B are example network diagrams 100A and 100B, respectively, utilized to describe various disclosed embodiments.

The network diagram 100A depicts an on-premises implementation in which a mitigator 130 is deployed on-premises with one or more compute servers 120-1 through 120-N (where N is an integer having a value equal to or greater than 1). As shown in the diagram 100A, the mitigator 130 communicates with a continuous integration/continuous development (CI/CD) manager 110, the compute servers 120, a mitigation knowledge base 140, and one or more detection tools 150.

The CI/CD manager 110 is configured to manage software components, hardware components, process components, and other parts of a computing infrastructure (not separately depicted) realized at least partially using the compute servers 120. To this end, the CI/CD manager 110 may be configured to deploy code uploaded by one or more developers (not shown), to enforce policies for the computing infrastructure (e.g., on the compute servers 120, both, and the like. When policies requiring signing code with artifacts are utilized as described herein, the CI/CD manager 110 may be configured to enforce such policies.

The compute servers 120 are configured to run processes and perform other activities pursuant to operation of the computing infrastructure in which they are deployed. In accordance with various disclosed embodiments, mitigation actions may be performed through the compute servers 120. To this end, in some embodiments, one or more artifacts are deployed in the compute servers 120, for example, as part of code deployed in the compute servers 120 via one or more code releases signed with the artifact as described herein. Accordingly, executable code of the artifact used to track and monitor mitigation activities as well as to perform code modification as described herein may be stored on or otherwise accessed and executed by the computer servers 120 in order to perform at least a portion of the disclosed embodiments.

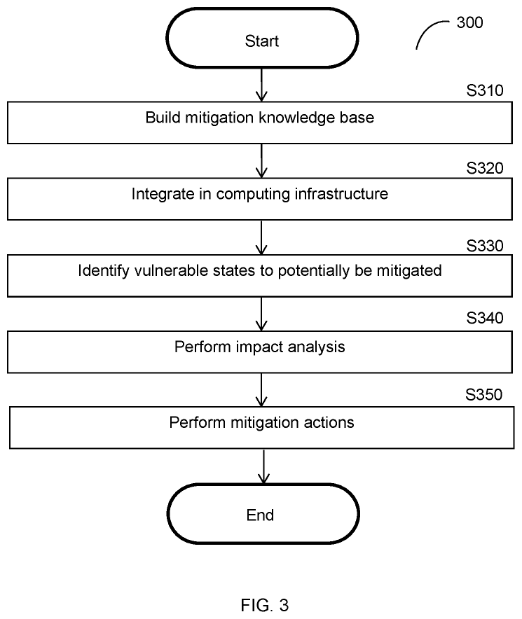

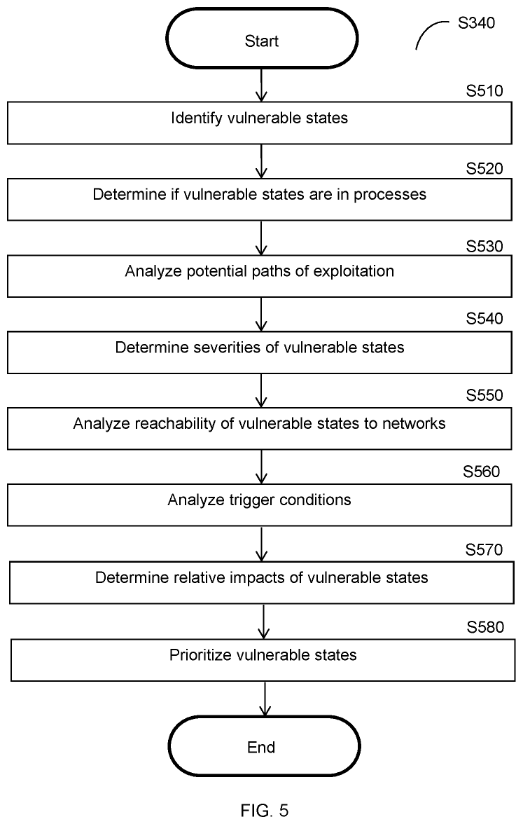

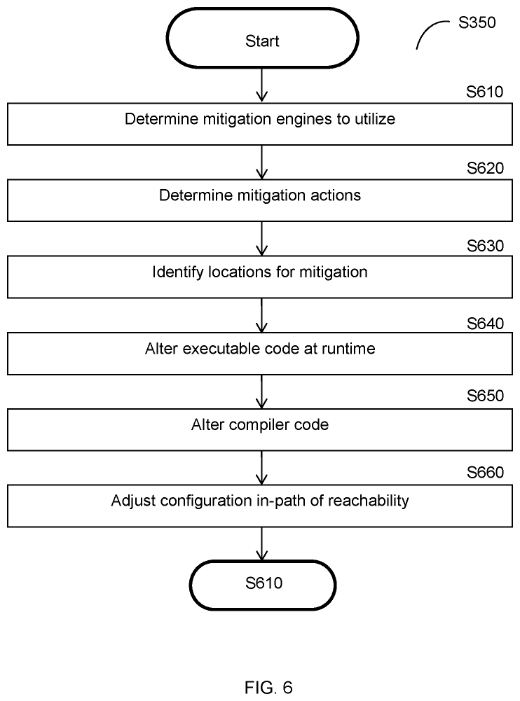

The mitigator 130 is configured to perform at least a portion of the disclosed embodiments such as, but not limited to, building a mitigation knowledge base 140, performing impact analysis for vulnerable states, and performing mitigation actions (e.g., as described below with respect to FIG. 3). To this end, the mitigator 130 may be configured with any or all of an impact analysis engine (IAE) 131, a reachability mitigation engine (ReME) 132, a runtime mitigation engine (RuME) 133, and a compile time mitigation engine (CTME) 134. The impact analysis engine 131 is configured to perform impact analysis, for example as described further below with respect to FIG. 5. The engines 132, 133, and 134, are configured to perform mitigation actions related to reachability, runtime code modification, and compiler time code modification, respectively, for example as described further below with respect to FIG. 6.

The mitigation knowledge base 140 defines one or more possible mitigation actions to be performed by mitigation engines (e.g., any of the engines 132, 133, and 134) for each known vulnerable state. More specifically, the mitigation knowledge base defines respective mitigation actions to be performed by each mitigation engine for different vulnerable states such as, but not limited to, vulnerable states defined in one or more common vulnerabilities and exposures (CVE, not shown). In some implementations, the mitigation knowledge base 140 may be built by one or more other systems (not shown).

The detection tools 150 include cybersecurity detection tools which are configured to detect potential vulnerable states such as, but not limited to, vulnerabilities and exposures. To this end, the detection tools 150 may be configured to generate and send alerts about any detected vulnerable states to the mitigator 130 for use in impact analysis, mitigation, both, and the like. The detection tools 150 may alert on the vulnerable states using definitions of the vulnerable states from a CVE such that different detection tools may alert on vulnerable states in a comparable manner.

The network diagram 100B depicts a cloud-based implementation in which the compute servers 120 are deployed in a cloud computing environment 125. The mitigator 130, the CI/CD manager 110, or both, may be deployed outside of such a cloud computing environment 125 and may communicate with the compute servers 120 via one or more cloud networks, the Internet, or any other networks (not shown) utilized to enable communications with the compute servers 120. Such networks may include, but are not limited to, a wireless, cellular or wired network, a local area network (LAN), a wide area network (WAN), a metro area network (MAN), the Internet, the worldwide web (WWW), similar networks, and any combination thereof.

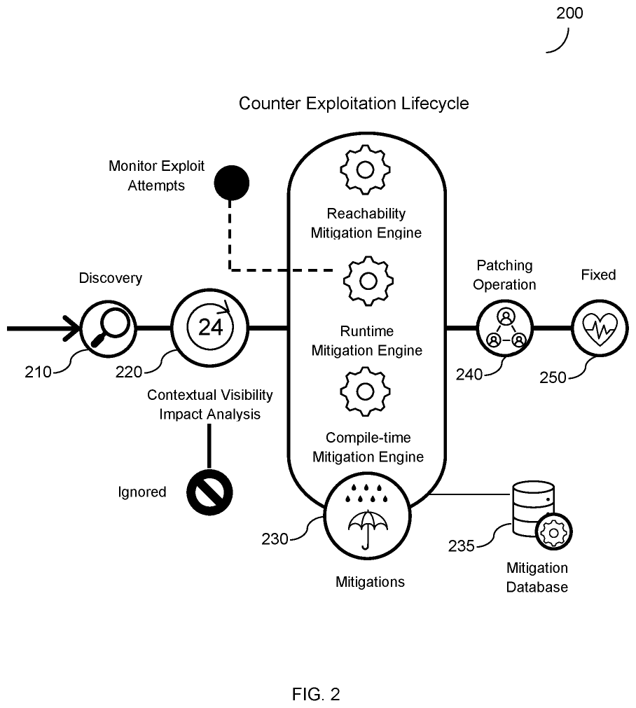

FIG. 2 is a flow diagram 200 illustrating a process including vulnerability mitigation.

The process shown in FIG. 2 begins with discovery 210. The discovery 210 may be based on alerts or other data provided by one or more detection tools configured to detect vulnerable states (e.g., the detection tools 150, FIGS. 1A-B). The discovery 210 results in identifying different potentially vulnerable states which may be, for example, vulnerabilities or exposures in a computing infrastructure.

Contextual visibility impact analysis 220 is performed for discovered vulnerable states. The impact analysis is performed based on multiple factors which relate to the potential impact a particular vulnerable state could have if exploited, likelihood of triggering such a vulnerable state, both, and the like. An example process for performing the impact analysis 220 is described further below with respect to FIG. 5.

Mitigations 230 are performed based on results of the contextual visibility impact analysis 220. Mitigation actions taken pursuant to mitigations 230 may be based on mitigation actions corresponding to respective vulnerable states defined in a mitigation database 235. Performing the mitigations 230 may further include monitoring for exploit attempts.

In accordance with various disclosed embodiments, the mitigations 230 may include, but are not limited to, reachability-related mitigation actions, runtime-related mitigation actions, compiler-related mitigation actions, combinations thereof, and the like. Reachability-related mitigation actions may include, but are not limited to, adjusting configuration of one or more components in the path of reachability between a component reflecting a vulnerable state and one or more assets to be protected from cyber threats. Runtime-related mitigation actions may include, but are not limited to, altering executable code at runtime. Compiler-related mitigation actions may include, but are not limited to, altering compiler code.

Mitigations 230 may be followed by patching operations 240. Such patching may provide more permanent fixes to the vulnerable states mitigated via mitigations 230. In this regard, the mitigations 230 may be utilized in order to mitigate vulnerable states more rapidly than such patching operations 240 can be performed, which in turn allows for securing the relevant assets more effectively than solutions which utilize patching as the main mitigation tool.

When mitigations 230 and any applicable patching operations 240 have been performed, an exploitable vulnerable state may be considered fixed 250. Detection tools may continue monitoring for additional vulnerable states.

FIG. 3 is a flowchart 300 illustrating a method for mitigating cyber vulnerabilities in computing infrastructure according to an embodiment. In an embodiment, the method is performed by the mitigator 130, FIG. 1.

At S310, a mitigation knowledge base is built. In an embodiment, the mitigation knowledge base defines one or more possible mitigation actions to be performed by mitigation engines for each known vulnerable state. More specifically, the mitigation knowledge base defines mitigation actions to be performed by each mitigation engine used for performing mitigation. Also, the known vulnerable states may be, but are not limited to, vulnerable states defined in a common vulnerabilities and exposures (CVE). As noted above, a CVE is a database including entries defining known vulnerabilities and exposures. The vulnerable states may include vulnerabilities, exposures, or both, defined in such a CVE.

In a further embodiment, the mitigation knowledge base may include a mapping between security controls (i.e., processes configured to detect vulnerabilities, mitigate vulnerabilities, or both) and exploitations of vulnerabilities which maps security controls to potential vulnerabilities which may be mitigated using those security controls. Such a mapping may be utilized when determining mitigation actions in order to identify appropriate security controls to use when performing mitigation actions which, as noted above, allows for tailoring mitigation to optimize security while minimizing potential negative effects of changes to assets.

In accordance with various disclosed embodiments, the mitigation knowledge base may define known vulnerable states (e.g., with respect to CVEs or other known vulnerability information) with respect to functions, rules, or other portions of assets which are known to be affected by certain vulnerable states. Changes in those functions or other portions of assets may be identified, for example, by cross-referencing industry standard databases to commit logs in order to identify functions which have been changed due to specific commits (i.e., functions which demonstrate differences from standards defined in such industry standard databases). This allows for identifying particular functions or other portions of code for which mitigation actions should be performed as described herein.

In yet a further embodiment, the mitigation knowledge base includes mitigation rules defined in mitigation tools, a predetermined value representing an effectiveness of each rule, and a predetermined value representing a risk of using each rule. This information may be utilized when determining which mitigation actions to be performed to mitigate a given vulnerable state. Moreover, information such as the risk of using each rule may be utilized in combination with impact analysis as described herein in order to make decisions about whether to utilize a particular mitigation rule given the potential impact of the vulnerable state to be mitigated, i.e., such that only vulnerable states likely to have high impact (e.g., having impact scores above a threshold as described herein) may be mitigated using mitigation rules known to have higher risk (e.g., above a threshold).

In an embodiment, a runtime mitigation rule to be realized via a runtime mitigation engine in order to mitigate a certain stack overflow vulnerability defines an addition of a certain exploit mitigation subprocess to a specific process that is known to contain that type of stack overflow vulnerability such that the process is in a vulnerable state with respect to that stack overflow vulnerability. Such a runtime mitigation rule may further define a function within a vulnerable library code or set of functions to be secured using such an exploit mitigation subprocess in order to protect against exploitation. Mitigation actions performed in accordance with such a runtime mitigation rule may be realized via one or more dynamic binary instrumentation (DBI) techniques. Such DBI techniques may allow, for example, for injecting and executing code within a process in order to analyze the process.

As a non-limiting example for a runtime mitigation rule, for a CVE that is a stack overflow bug in a function of a process, the runtime mitigation rule may indicate that such a bug is to be mitigated by adding a control flow integrity subprocess to the function via DBI techniques that would result in crashing of the process when the stack overflow bug is exploited rather than resulting in leakage of sensitive data or remote code execution.

In another embodiment, a compile time mitigation rule defines instructions for altering source code which may mitigate the risk of exploitation of a certain vulnerability even without upgrading a component having a vulnerable state related to that vulnerability. As a non-limiting example, such source code changes may include adding an “if” statement to a certain function known to relate to a particular vulnerability in order to prevent certain inputs of the function to lead to an edge case in which the vulnerability is triggered even if the underlying bug in the source code is not fixed.

The compile time mitigation rules may be defined with respect to known code changes, for example, code changes which are known to have previously solved certain vulnerabilities. Such code changes may include, for example additions of statements or other alterations which prevent flows of a function or other portion of an asset leading to vulnerable code. Moreover, the code changes may be defined with increased granularity with respect to specific versions of an asset or otherwise with respect to specific software versions. In some further embodiments, proposed changes may be provided to an analyst, and the analyst may override certain proposed changes (e.g., changes which the analyst decides may negatively affect the code).

In yet another embodiment, a first reachability mitigation rule defines identification of a security control integration that is present in a computing environment in which an asset having a vulnerable state is observed, and a second reachability mitigation rule defines detection or mitigation of an exploitation attempt of a specific vulnerability via the identified security control integration. As a non-limiting example, when a web application firewall (WAF) was identified as protecting an asset that is vulnerable to a particular CVE, the reachability mitigation rules define a search for a certain set of characters that are known to be indicative of an exploitation attempt via this CVE. The reachability mitigation action implementing these reachability mitigation rules may be instructed to add a rule to the WAF which would tailor the detection such that an alert only triggers against traffic directed to the asset having the vulnerable state.

It should be noted that S310 is depicted as part of a single flow with other steps of FIG. 3 merely for example purposes, but that the disclosed embodiments are equally applicable to building the mitigation knowledge base in advance prior to other steps of the flow. Further, the mitigation knowledge base may be updated or otherwise new mitigation knowledge bases to be used in subsequent iterations may be built in parallel to other steps without departing from the scope of the disclosed embodiments.

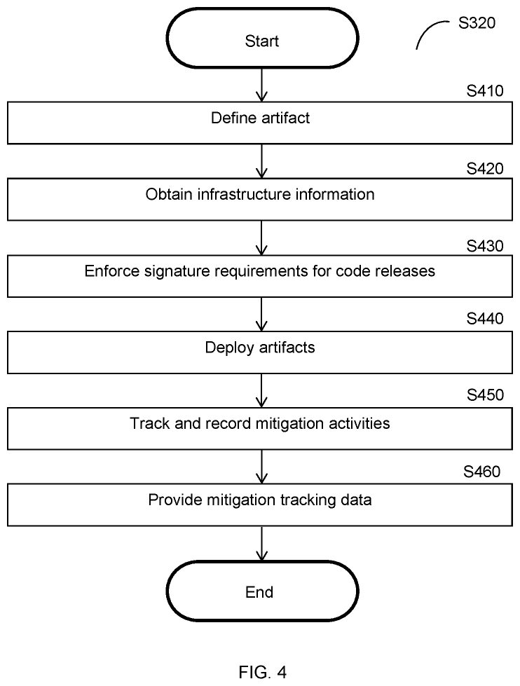

At S320, integration is performed so as to integrate components used for mitigation in a computing infrastructure. In an embodiment, integration may include deploying an artifact in the computing infrastructure. The artifact may be configured to track and record mitigation activities as well as to modify code at runtime and compile time. Deploying the artifact may include, but is not limited to, deploying instances of executable code of the artifact, for example by signing code releases based on the artifact. In a further embodiment, such integration is performed as described further below with respect to FIG. 4.

At S330, potential vulnerable states to be mitigated are identified. In an embodiment, the potential vulnerable states may be identified based on alerts, notifications, or other data generated by detection tools (e.g., the detection tools 150, FIGS. 1A-B).

At S340, impact analysis is performed. In an embodiment, S340 includes generating a score for each potential vulnerable state identified at S330. Such a score may represent the impact of the detected vulnerable state as a potential vulnerability or exposure during runtime, which in turn may be utilized in order to make decisions about prioritizing mitigation of different vulnerable states. To this end, S340 may further include prioritizing vulnerable states based on the scores. This impact analysis may be automated and performed without manual user intervention in order to automate mitigation, to mitigate vulnerable states before they become full security incidents, and to avoid subjective decision making about prioritizing vulnerable states. An example method for prioritizing vulnerable states using impact analysis is described further below with respect to FIG. 5.

The impact analysis may be performed based on factors such as, but not limited to, whether each vulnerable state is detected in a process or system having built-in processes, whether each vulnerable state imposes a path of exploitation, a severity of each vulnerable state, a reachability of each vulnerable state to a network through which protected assets can be accessed, complexity of trigger conditions for triggering the vulnerable state (e.g., to trigger the state to cause improper exposure of assets or otherwise grant improper access), combinations thereof, portions thereof, and the like. These factors may be assigned weighted values, and the weighted values may be utilized to determine the score for each vulnerable state.

At S350, one or more mitigation actions are performed with respect to the identified vulnerable states. More specifically, the mitigation actions may be performed based on the impact analysis so as to prioritize performing mitigation actions with respect to higher impact vulnerable states (e.g., vulnerable states having higher scores).

In an embodiment, S350 includes applying one or more mitigation engines, where each mitigation engine is configured to perform mitigation actions related to adjusting components. In a further embodiment, the mitigation engines include one or more of a reachability mitigation engine, a runtime mitigation engine, and a compile time mitigation engine. An example mitigation process including processes for performing mitigation actions using such mitigation engines is described further below with respect to FIG. 5.

In a further embodiment, which mitigation engines to use, in which order the mitigations are used, or both, may also be determined based on the impact analysis. That is, certain mitigation engines may be utilized only for vulnerable states having impact scores above a threshold or within a predetermined range. In this regard, it is noted that certain mitigation activities may be more suitable than others depending on urgency, and such urgency may be determined based on the likelihood of impact of a given vulnerable state. To this end, S350 may further include determining which mitigation engines to use (and, therefore, which types of mitigation actions to perform) based on results of impact analysis using one or more mitigation engine determination rules.

As an example, for a high impact vulnerable state (e.g., having an impact score above a threshold), the determined mitigation engines may include a runtime mitigation action since altering runtime execution of components related to the vulnerable state may be considered a strong mitigation action. The specific mitigation actions taken using such a runtime mitigation engine may include blocking execution of an affected process, which may be considered an extreme measure reserved only for particularly high impact vulnerable states.

FIG. 4 is a flowchart S320 illustrating a method for integrating a mitigation tool in a computing infrastructure according to an embodiment.

At S410, an artifact is defined. The artifact is defined such that it is configured at least to can track and record mitigation activities being performed in a computing infrastructure in which it is deployed, as well as to make adjustments within the computing infrastructure (e.g., adjusting configurations of components, altering executable code at runtime, altering compiler code, combinations thereof, and the like). The artifact can be used as a hook to make changes at runtime and at compile time in order to perform mitigation actions as described herein.

In an embodiment, the artifact is or includes instructions in the form of executable code that, when executed by a processing circuitry, configure the processing circuitry to at least perform the activities defined by the instructions of the artifact. To this end, defining the artifact may include defining such instructions and storing a copy of executable instructions encoding such instructions so that the executable code may be copied and deployed.

Once the artifact has been defined, instructions of the artifact may be incorporated into code releases via signing and utilized to implement various disclosed embodiments. To this end, the artifact may be defined as part of a code signing certificate or other piece of data to be used for signing code releases such that any signatures signed using that certificate or data includes an instance of the artifact in the form of a copy of the executable code of the artifact. This, in turn, allows the artifact to serve as a hook in the code release for performing at least a portion of the disclosed embodiments. Such code releases may occur when new components are deployed in the computing infrastructure, i.e., the code releases may include executable code of software components or code to be used by hardware components, and the code of such code releases may include the executable code of the artifact such that the artifact is deployed with any components deployed as part of a given code release signed using the artifact.

At S420, infrastructure information about a computing infrastructure is obtained. The computing infrastructure is a computing infrastructure for which the artifact will be deployed. The infrastructure information may include, but is not limited to, components, processes executed by those components, information indicating which components communication with which other components, combinations thereof, and other information which may be relevant to relative locations where the artifact can be deployed in order to be capable of performing the mitigation actions as described herein. More specifically, the infrastructure information may include information potentially related to code releases (e.g., where code may be deployed), and artifacts may be deployed with each code release such that one or more artifacts are deployed as part of code introduced in any given code release.

At S430, requirements for signatures for code releases are enforced on the computing infrastructure via the artifact. To this end, S430 may include enforcing one or more policies requiring all code releases in the computing infrastructure to be signed using an instance of the artifact. Such policies may be implemented in the computing infrastructure in order to facilitate the disclosed embodiments. In some implementations, the requirements may be enforced via a CI/CD manager (e.g., the CI/CD manager 110, FIGS. 1A-B). To this end, in some embodiments, S430 may include sending data indicating such policies to the CI/CD manager or otherwise instructing the CI/CD manager to enforce such policies. Moreover, S430 may include sending a copy of the executable code of the artifact to be used for signing according to the signing policies being enforced.

At S440, the artifacts are deployed with respect to the computing infrastructure. Each artifact is deployed such that it can track, and record mitigation activities being performed in at least a portion of the computing infrastructure, as well as such that it can make adjustments within the relevant portion of the computing infrastructure (e.g., adjusting configurations of components, altering executable code at runtime, altering compiler code, combinations thereof, and the like). More specifically, in accordance with the policies enforced at S430, an instance of the artifact may be created and deployed in one or more portions of code for every code release via signing of the code release with such an artifact instance.

As noted above, the artifact may be realized as a set of instructions in the form of executable code included in a certificate or other data incorporated in signatures. To this end, the artifact is deployed as part of deployment of any code releases signed using the artifact.

At S450, mitigation activities being performed in the computing infrastructure are tracked, and data indicating the mitigation activities are recorded via the artifact. The data recorded by the artifact may include an indication of mitigation actions performed with respect to each process or other component in the infrastructure.

At S460, the recorded mitigation tracking data is provided, for example, when needed in order to make decisions about mitigation actions to be performed. As an example, when mitigation actions are determined as described below with respect to S620, it may be checked whether the determined mitigation actions have been performed with respect to the processes which might be affected by the vulnerable state and, if any mitigation actions have already been performed with respect to that process, those mitigation actions are not performed again.

It should be noted that the steps of FIG. 4 are depicted all as part of the process S320 for simplicity, but that at least some of those steps may be performed in parallel with each other or with certain steps of the other flowcharts described herein without departing from the scope of the disclosure.

FIG. 5 is a flowchart S340 illustrating a method for prioritizing vulnerable states based on impact analysis according to an embodiment.

At S510, one or more vulnerable states to be analyzed are identified. The vulnerable states to be analyzed may include, but are not limited to, vulnerable states detected by one or more cybersecurity detection tools or systems.

At S520, it is determined whether each vulnerable state is detected in a process or in an operating system having built-in processes. In an embodiment, S520 may include collecting information from live processes having built-in mitigation defenses indicating whether such defenses were active.

In a further embodiment, such collection may be realized at least in part by executing a script that analyzes the memory and accesses one or more mitigation tools (e.g., existing agents) deployed and configured to collect forensic data with respect to the process. Executing a script configured to perform such analysis which collects data via existing agents allows for realizing the collection of information to be used for detecting vulnerable states without necessarily deploying an additional agent in order to collect such data.

At S530, potential paths of exploitation are analyzed for each vulnerable state. In an embodiment, S530 includes analyzing a code path from a vulnerable process to another process or function serving as an asset to be protected. The analysis may be based on data retrieved from other sources, e.g., other components deployed in or with respect to the computing infrastructure indicating communications between and among components of the computing infrastructure and, more specifically, between processes executed via the computing infrastructure. In a further embodiment, S530 may include creating a mapping of such potential paths of exploitation to be used for impact analysis, for example as described further below.

At S540, a severity of each vulnerable state is determined. In an embodiment, the severity may be a predetermined value defined in one or more severity rules based on known types of alerts or otherwise severity values corresponding to predetermined data provided by detection tools.

At S550, a reachability is determined for each vulnerable state with respect to one or more networks or subnetworks through which protected assets (e.g., processes or other components deployed in the infrastructure) are accessible. In an embodiment, S550 may include determining whether a process or other component affected by the vulnerable state is capable of reaching the Internet or a network or subnetwork where one or more predetermined assets (e.g., processes or components deployed in the computing infrastructure) to be protected from vulnerabilities reside. Such determination may be based on the output of detection tools (e.g., the detection tools 150, FIGS. 1A-B), which may be configured to provide indications of whether certain vulnerable states have reachability to particular networks or components. To this end, in some embodiments, S550 includes creating a mapping including paths from different protected assets which go through other components that lead to the Internet or one or more other external networks. Such mapping may be utilized, for example, for impact analysis as described further below.

In an embodiment, S550 may include identifying one or more paths from each protected asset to the Internet or a public-facing network or subnetwork. Moreover, the path may be defined with respect to security control integrations which are configured to detect vulnerabilities, mitigate vulnerabilities, or both. In a further embodiment, S550 includes applying one or more predetermined reachability analysis rules defined with respect to predetermined security control integrations, where each security control integration is a process or other component configured to detect vulnerabilities, to mitigate vulnerabilities, or both. Using paths defined with respect to security control integrations allows for providing visibility into the security controls which are in place within a given computing infrastructure. In combination with awareness regarding the posture of the computing infrastructure, mitigation rules can be defined more granularly in order to optimize mitigation while minimizing potential negative effects of changes performed pursuant to mitigation.

At S560, trigger conditions are analyzed for each vulnerable state in order to determine a relative complexity of triggering each vulnerable state. To this end, S560 may include determining a relative level of complexity of the conditions required to be met in order for the vulnerable state to cause unintended access or disruption to normal processes. Determining such a complexity may further include applying one or more trigger complexity rules with respect to potential conditions for triggering vulnerable states.

At S570, impacts of the vulnerable states are determined. In an embodiment, S570 includes generating scores for the vulnerable states based on one or more factors such as, but not limited to, whether each vulnerable state is detected in a process or system having built-in processes, whether each vulnerable state imposes a path of exploitation, a severity of each vulnerable state, a reachability of each vulnerable state to a network through which protected assets can be accessed, complexity of trigger conditions for triggering the vulnerable state (e.g., to trigger the state to cause improper exposure of assets or otherwise grant improper access), combinations thereof, portions thereof, and the like. In a further embodiment, these factors may be assigned weighted values and aggregated in order to determine a weighted score for each vulnerable state. To this end, S570 may include determining a value representing each factor.

At S580, the vulnerable states are prioritized based on the impacts determined at S570. In an example implementation, S580 may include ranking the vulnerable states from highest impact to lowest impact, where higher impact vulnerable states are prioritized over lower impact vulnerable states.

FIG. 6 is a flowchart S360 illustrating a method for performing mitigation actions in a computing infrastructure according to an embodiment.

At S610, one or more mitigation engines to be utilized for mitigating a vulnerable state are determined. In an embodiment, the mitigation engines to be utilized are determined based on an impact of the vulnerable state to be mitigated, for example, as defined with respect to impact scores determined for the vulnerable state such as those determined as described above with respect to S570.

In an embodiment, S610 includes applying one or more mitigation engine selection rules based on an impact score of the vulnerable state. Such mitigation engine selection rules may define thresholds or ranges of impact scores to be used for selecting mitigation engines.

As an example for selecting mitigation engines, a reachability mitigation engine may be utilized for a vulnerable state when an impact score of the vulnerable state is above a first threshold, a compiler time mitigation engine may be utilized when an impact score of the vulnerable state is above a second threshold, and a runtime mitigation engine may be utilized when an impact score of the vulnerable state is above a third threshold, where the second threshold is higher than the first threshold and the third threshold is higher than the second threshold. In this non-limiting example, adjusting a configuration of components in the path of reachability may be considered a less extreme action than altering compiler code, and likewise altering compiler code may be considered a less extreme action than altering runtime code, so their respective thresholds are set such that performing mitigation activities related to compiler time code and runtime executable code are only performed as escalations to higher impact vulnerabilities and exposures.

Further, in some implementations, multiple engines may be utilized as each threshold is reached. In a further non-limiting example, both the reachability mitigation engine and the compiler time mitigation engine may be utilized when an impact score of a vulnerable state is above the second threshold.

At S620, one or more mitigation actions to be performed for the vulnerable state are determined. In an embodiment, S620 includes applying one or more mitigation action determination rules. Such rules may define predetermined mitigation actions to be performed based on the mitigation engines to be utilized, a type of vulnerable state (e.g., vulnerability versus exposure, specific types of vulnerabilities or exposures, etc.), likely impact of the vulnerable state (e.g., based on an impact score as discussed above), combinations thereof, portions thereof, and the like.

In a further embodiment, S620 also includes determining an order for performing the mitigation actions or otherwise prioritizing the mitigation actions. Such an order may be utilized to make further decisions about prioritizing available resources for performing mitigation when all of the mitigation actions cannot be performed in parallel (e.g., because insufficient resources are available to perform all of those actions at the same time), for example to perform mitigation actions related to higher impact vulnerable states before mitigation actions for lower impact vulnerable states (e.g., as determined by comparing impact scores), to perform more extreme mitigation actions before less extreme mitigation actions (e.g., based on predetermined rules defining a relative degree of extremeness of different mitigation actions), both, and the like. As a non-limiting example, if prioritization of mitigation actions is needed, actions related to altering runtime code may be prioritized over actions related to adjusting configurations along the path of reachability since runtime configuration changes may have a more immediate effect and therefore can more efficiently mitigate high impact vulnerabilities.

At S630, locations for performing the mitigation actions are determined. The locations are defined with respect to the computing infrastructure. More specifically, the locations may include locations for which artifacts are deployed, i.e., locations accessible to instructions included among the artifact which the artifact can adjust, alter, or otherwise affect in order to perform one or more mitigation actions as discussed herein.

It should be noted that S640 through S660 which are now described may be performed via respective mitigation actions. More specifically, the altering of executable code at runtime may be performed by a runtime mitigation engine, the altering of the compiler code may be performed by a computer mitigation engine, and the configuration adjustments may be performed by a reachability mitigation engine. To this end, only certain actions among S640 through S660 may be performed depending on which mitigation engines were selected to be utilized at S610.

At S640, executable code is altered at runtime. In an embodiment, S640 includes changing a memory in which a library used for executing the code resides in real-time such that the vulnerable state is not exploited via code that is currently being executed. As a non-limiting example, such a change may include adding an “if” statement to the executable code, thereby preventing execution of at least a portion of the executable code.

In a further embodiment, the runtime engine which performs such alteration at runtime may be realized by implementing dynamic binary instrumentation (DBI). DBI is a process of monitoring or measuring execution of a binary and its behavior during runtime, for example with respect to resource usage. The results of such monitoring or measurements may be utilized to determine, for example, portions of executable code to be altered at runtime.

At S650, compile time code is altered. More specifically, compile time code may be altered in order to add or otherwise modify one or more portions of code such that the added or otherwise modified code prevents execution of one or more other parts of code. In some embodiments, the alteration of the compile time code may be performed in order to secure the executable code regardless of the particular vulnerable state being mitigated, for example when a vulnerable state is detected in a production environment.

At S660, configurations are adjusted for one or more components deployed in-path of reachability between the processes affected by the vulnerable state and one or more assets to be protected. In an embodiment, the altered configurations are for components deployed along one of the potential paths of exploitation between vulnerable states and protected assets, for example as described above with respect to S530. As a non-limiting example, S660 may include instructing a firewall to inspect all traffic coming from a particular source, to block traffic to or from particular components, and the like.

In various embodiments, execution proceeds to continue with S610, where mitigation actions are performed with respect to another vulnerable state. In at least some implementations, execution may continue in this manner continuously as new vulnerable states are discovered.

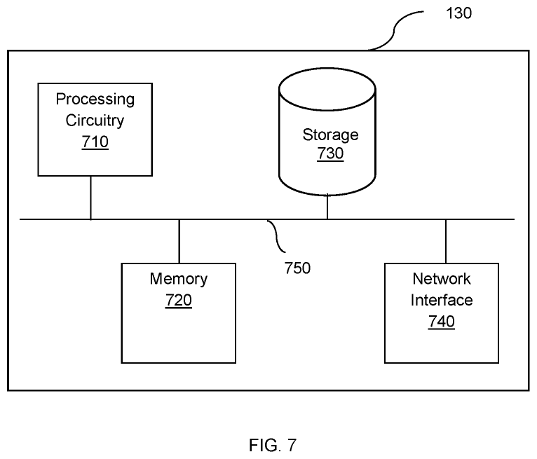

FIG. 7 is an example schematic diagram of a mitigator 130 according to an embodiment. The mitigator 130 includes a processing circuitry 710 coupled to a memory 720, a storage 730, and a network interface 740. In an embodiment, the components of the mitigator 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the mitigator 130 to communicate with, for example, the compute servers 120, the mitigation knowledge base 140, the CI/CD manager 110, the detection tools 150, and the like.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for mitigating vulnerabilities and exposures, comprising:
determining at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and
performing the at least one mitigation action via at least one mitigation engine of the plurality of mitigation engines.

2. The method of claim 1, further comprising:
causing deployment of at least one instance of an artifact in a computing infrastructure, wherein the at least one mitigation action is performed via the deployed at least one instance of the artifact.

3. The method of claim 2, wherein the at least one instance of the artifact is configured to track mitigation activities performed in the computing infrastructure in order to create a record of the mitigation activities performed in the computing infrastructure, wherein the at least one mitigation action is determined based on the record.

4. The method of claim 2, further comprising:
defining the artifact via a set of executable instructions; and
causing enforcement of at least one policy requiring signing code releases in the computing infrastructure with respective instances of the artifact, wherein the at least one instance of the artifact is deployed via the enforcement of the at least one policy.

5. The method of claim 1, further comprising:
performing impact analysis on the first vulnerable state in order to determine an impact score for the first vulnerable state, wherein the at least one mitigation action is performed based on the impact score for the first vulnerable state.

6. The method of claim 5, wherein the at least one mitigation action is at least one first mitigation action, further comprising:
prioritizing the at least one first mitigation action with respect to a plurality of second mitigation actions based on the impact analysis.

7. The method of claim 6, further comprising:
selecting the at least one mitigation engine from among the plurality of mitigation engines based on the prioritizing of the at least one first mitigation action with respect to the plurality of second mitigation actions.

8. The method of claim 1, wherein the plurality of mitigation engines includes a reachability mitigation engine, wherein the determined at least one mitigation action includes adjusting a configuration of at least one component in a path of reachability between the first vulnerable state and at least one asset.

9. The method of claim 1, wherein the plurality of mitigation engines includes a runtime mitigation engine, wherein the determined at least one mitigation action includes altering executable code at runtime.

10. The method of claim 9, wherein the altering of the executable code at runtime includes modifying at least one of: at least one function, and at least one rule.

11. The method of claim 1, wherein the plurality of mitigation engines includes a compiler time mitigation engine, wherein the determined at least one mitigation action includes altering compiler time code.

12. A non-transitory computer readable medium having stored thereon instructions for causing a processing circuitry to execute a process, the process comprising:
determining at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and
performing the at least one mitigation action via at least one mitigation engine of the plurality of mitigation engines.

13. A system for mitigating vulnerabilities and exposures, comprising:
a processing circuitry; and
a memory, the memory containing instructions that, when executed by the processing circuitry, configure the system to:
determine at least one mitigation action for mitigating a first vulnerable state using a mitigation knowledge base, wherein the mitigation knowledge base defines a plurality of mitigation actions for each of a plurality of second vulnerable states, wherein the plurality of mitigation actions defined for each second vulnerable state includes at least one mitigation action for a plurality of mitigation engines; and
perform the at least one mitigation action via at least one mitigation engine of the plurality of mitigation engines.

14. The system of claim 13, wherein the system is further configured to:
cause deployment of at least one instance of an artifact in a computing infrastructure, wherein the at least one mitigation action is performed via the deployed at least one instance of the artifact.

15. The system of claim 14, wherein the at least one instance of the artifact is configured to track mitigation activities performed in the computing infrastructure in order to create a record of the mitigation activities performed in the computing infrastructure, wherein the at least one mitigation action is determined based on the record.

16. The system of claim 14, wherein the system is further configured to:
define the artifact via a set of executable instructions; and
cause enforcement of at least one policy requiring signing code releases in the computing infrastructure with respective instances of the artifact, wherein the at least one instance of the artifact is deployed via the enforcement of the at least one policy.

17. The system of claim 13, wherein the system is further configured to:
perform impact analysis on the first vulnerable state in order to determine an impact score for the first vulnerable state, wherein the at least one mitigation action is performed based on the impact score for the first vulnerable state.

18. The system of claim 17, wherein the at least one mitigation action is at least one first mitigation action, wherein the system is further configured to:
prioritize the at least one first mitigation action with respect to a plurality of second mitigation actions based on the impact analysis.

19. The system of claim 18, wherein the system is further configured to:
select the at least one mitigation engine from among the plurality of mitigation engines based on the prioritizing of the at least one first mitigation action with respect to the plurality of second mitigation actions.

20. The system of claim 13, wherein the plurality of mitigation engines includes a reachability mitigation engine, wherein the determined at least one mitigation action includes adjusting a configuration of at least one component in a path of reachability between the first vulnerable state and at least one asset.

21. The system of claim 13, wherein the plurality of mitigation engines includes a runtime mitigation engine, wherein the determined at least one mitigation action includes altering executable code at runtime.

22. The system of claim 21, wherein the altering of the executable code at runtime includes modifying at least one of: at least one function, and at least one rule.

23. The system of claim 13, wherein the plurality of mitigation engines includes a compiler time mitigation engine, wherein the determined at least one mitigation action includes altering compiler time code.
